(19) United States
(12) Patent Application Publication
(10) Pub. No.: US 2024/0314746 A1
(43) Pub. Date: Sep. 19, 2024

(54) RESOURCE UNIT SELECTIVE TRANSMISSION SCHEME FOR LOW LATENCY TRANSMISSION IN A WIRELESS NETWORK

(71) Applicant: NEWRACOM, Inc., Irvine, CA (US)

(72) Inventors: Heejung YU, Daejeon (KR); Joonsoo LEE, Seoul (KR); Si-Chan NOH, Seoul (KR)

(73) Assignee: NEWRACOM, Inc., Irvine, CA (US)

(21) Appl. No.: 18/605,590

(22) Filed: Mar. 14, 2024

Related U.S. Application Data
(60) Provisional application No. 63/490,942, filed on Mar. 17, 2023.

(51) Int. Cl. H04W 72/04; H04L 1/00

(52) U.S. Cl. CPC H04W 72/04; H04L 1/0061

(57) ABSTRACT

Disclosed herein is a method performed by a wireless device in a wireless network to transmit data using a resource unit selective transmission (RUST) transmission scheme. The method includes encoding source data using an error correcting encoding to generate encoded bits, generating a plurality of sub-blocks based on the encoded bits, determining an assignment of the plurality of sub-blocks to a plurality of resource unit groups, and wirelessly transmitting the plurality of sub-blocks in the plurality of resource unit groups according to the assignment of the plurality of sub-blocks to the plurality of resource unit groups.

### CROSS-REFERENCE TO RELATED APPLICATION

This application claims the benefit of U.S. Provisional Application No. 63/490,942, filed Mar. 17, 2023, titled, “Resource unit selective transmission for low latency transmission in beyond IEEE 802.11be,” which is hereby incorporated by reference.

### TECHNICAL FIELD

The present disclosure generally relates to wireless communications, and more specifically, relates to transmitting data using a resource unit selective transmission (RUST) transmission scheme to allow low latency transmission in a wireless network.

### BACKGROUND

Institute of Electrical and Electronics Engineers (IEEE) 802.11 is a set of physical and Media Access Control (MAC) specifications for implementing Wireless Local Area Network (WLAN) communications. These specifications provide the basis for wireless network products using the Wi-Fi brand managed and defined by the Wi-Fi Alliance. The specifications define the use of the 2.400-2.500 Gigahertz (GHz) as well as the 4.915-5.825 GHz bands. These spectrum bands are commonly referred to as the 2.4 GHz and 5 GHz bands. Each spectrum is subdivided into channels with a center frequency and bandwidth. The 2.4 GHz band is divided into 14 channels spaced 5 Megahertz (MHz) apart, though some countries regulate the availability of these channels. The 5 GHz band is more heavily regulated than the 2.4 GHz band and the spacing of channels varies across the spectrum with a minimum of a 5 MHz spacing dependent on the regulations of the respective country or territory.

WLAN devices are currently being deployed in diverse environments. These environments are characterized by the existence of many Access Points (APs) and non-AP stations (STAs) in geographically limited areas. Increased interference from neighboring devices gives rise to performance degradation. Additionally, WLAN devices are increasingly required to support a variety of applications such as video, cloud access, and offloading. Video traffic, in particular, is expected to be the dominant type of traffic in WLAN deployments. With the real-time requirements of some of these applications, WLAN users demand improved performance.

The scope of future wireless networking standards (e.g., beyond IEEE 802.11be) is expected to include low latency traffic delivery for real-time services such as virtual reality (VR), augmented reality (AR), and/or mixed reality (MR). In current wireless networking standards, if a station (STA) acquires a transmission opportunity (TXOP), other STAs are not allowed to transmit during the TXOP to guarantee the safe transmission of the TXOP owner's frames. TXOPs can last for a relatively long time. Such an operational scenario prevents low latency transmission (LLT) in the wireless network.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example wireless local area network (WLAN) with a basic service set (BSS) that includes a plurality of wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates Inter-Frame Space (IFS) relationships, in accordance with some embodiments of the present disclosure.

FIG. 5 illustrates a Carrier Sense Multiple Access/Collision Avoidance (CSMA/CA) based frame transmission procedure, in accordance with some embodiments of the present disclosure.

FIG. 6 shows a table comparing various iterations of Institute of Electrical and Electronics Engineers (IEEE) 802.11 standard, in accordance with some embodiments of the present disclosure.

FIG. 7 shows a table, which describes fields of an Extreme High Throughput (EHT) frame format, in accordance with some embodiments of the present disclosure.

FIG. 8 is a diagram showing a simple wireless local area network (WLAN) system.

FIG. 9 is a diagram showing a frame exchange sequence in the simple WLAN system according to existing wireless networking standards (e.g., IEEE 802.11ax).

FIG. 10 is a diagram showing a HARQ-based approach for generating sub-blocks for a RUST transmission scheme, according to some embodiments.

FIG. 11 is a diagram showing a repetition-based approach for generating sub-blocks for a RUST transmission scheme, according to some embodiments.

FIG. 12 is a diagram showing example frequency responses of two uplink channels, according to some embodiments.

FIG. 13 is a diagram showing an example assignment of sub-blocks to resource unit groups that is based on the channel gains of resource unit groups, according to some embodiments.

FIG. 14 is a diagram showing an example of a simultaneous transmission of a RUST data frame and a low latency data frame, according to some embodiments.

FIG. 15 is a diagram showing an example of a frame exchange sequence for a RUST transmission scheme, according to some embodiments.

FIG. 16A is a flow diagram showing a method for transmitting data using a RUST transmission scheme, according to some embodiments.

FIG. 16B is a flow diagram showing a method for transmitting a RUST data frame in response to receiving a RUST trigger frame, according to some embodiments.

FIG. 17 is a flow diagram showing a method for initiating a RUST transmission, according to some embodiments.

FIG. 18 is a flow diagram showing a method for transmitting a data frame in the middle of a RUST data frame transmission, according to some embodiments.

### DETAILED DESCRIPTION

One aspect of the present disclosure generally relates to wireless communications, and more specifically, relates to transmitting data using a resource unit selective transmission (RUST) scheme to allow low latency transmission in a wireless network.

As mentioned above, in current wireless networking standards, if a station (STA) acquires a transmission opportunity (TXOP), other STAs are not allowed to transmit during the TXOP to guarantee the safe transmission of the TXOP owner's frames. TXOPs can last for a relatively long time. Such an operational scenario prevents low latency transmission (LLT) in the wireless network.

According to some embodiments, a station (STA) in a wireless network may transmit data using a resource unit selective transmission (RUST) transmission scheme to allow for low latency transmission in a wireless network. With the RUST transmission scheme, a STA may encode source data using an error correcting encoding (e.g., LDPC encoding) to generate encoded bits. The STA may generate a plurality of sub-blocks based on the encoded bits. For example, in a HARQ-based (hybrid automatic repeat request) approach, the STA may generate the plurality of sub-blocks based on partitioning the encoded bits into sub-blocks. In a repetition-based approach, the STA may generate the plurality of sub-blocks based on repeating at least some of the bits of the encoded bits in multiple sub-blocks. Due to the use of HARQ or repetition, the receiver may be able to recover the source data even if it is only able to successfully receive and decode a subset of the sub-blocks. Each sub-block may contribute differently to the ability of the receiver to recover the source data. The STA may determine an assignment of sub-blocks to resource unit groups. The sub-blocks may be assigned to resource unit groups based on their contribution to the ability to recover the source data and the channel gains of the resource unit groups. For example, the sub-block that contributes the most to the ability to recover the source data may be assigned to the resource unit group that is determined to have the highest channel gain and the sub-block that contributes the least to the ability to recover the source data may be assigned to the resource unit group that is determined to have the lowest channel gain. The STA may then transmit the sub-blocks in the resource unit groups according to the determined assignment of sub-blocks to resource unit groups. The sub-blocks may be transmitted in multiple Physical Layer Protocol Data Units (PPDUs) in different resource unit groups in an orthogonal frequency-division multiplexing (OFDM) manner. The sub-blocks may collectively form what is referred to herein as a RUST data frame.

A STA that has low latency data to transmit to the receiver (which may be referred to herein as a LLT STA) may transmit a low latency data frame that includes the low latency data to the receiver using one of the resource unit groups in which the RUST data frame was transmitted. For example, the LLT STA may transmit the low latency data frame using the resource unit group in which the sub-block that contributes the least to the ability to recover the source data is transmitted (the resource unit group that was determined to have the lowest channel gain).

As a result of the above operations, the receiver may simultaneously receive the RUST data frame and the low latency data frame. The receiver may be able to recover the source data even if the receiver is not able to successfully receive and decode all of the sub-blocks that form the RUST data frame. Also, the receiver may be able to decode the low latency data frame to obtain the low latency data (e.g., because the channel gain of the resource unit group may be higher for the low latency data frame compared to the sub-block of the RUST data frame that was transmitted in the resource unit group). As such, the use of the RUST transmission scheme allows the LLT STA to transmit low latency data to the receiver while the RUST data frame is being transmitted (that is, both the low latency data frame and the RUST data frame may be transmitted simultaneously to the receiver), without impacting the receiver's ability to recover the source data included in the RUST data frame. As a result, the LLT STA may be able to transmit low latency data to the receiver without having to wait for the transmission of the RUST data frame to finish, which allows for low latency transmission.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

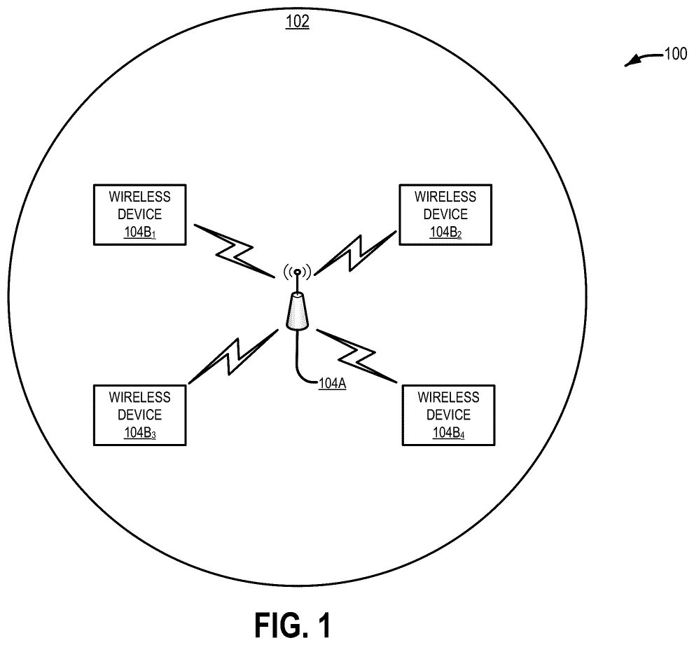

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/bc). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for case of description, only the non-AP STAs may be referred to as STAs. Although shown with four non-AP STAs (e.g., the wireless devices 104B₁-104B₄), the WLAN 100 may include any number of non-AP STAs (e.g., one or more wireless devices 104B).

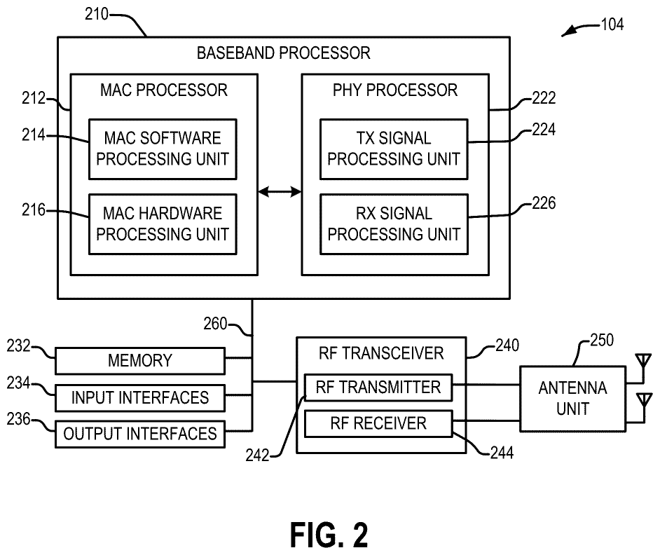

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

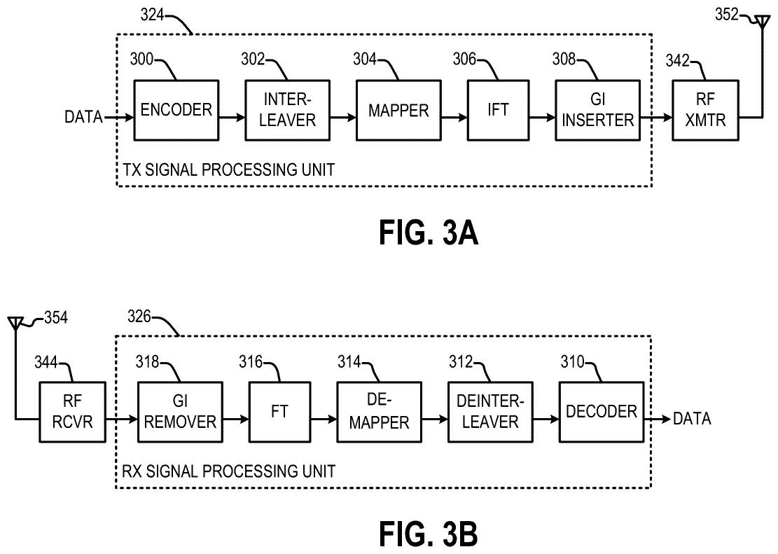

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

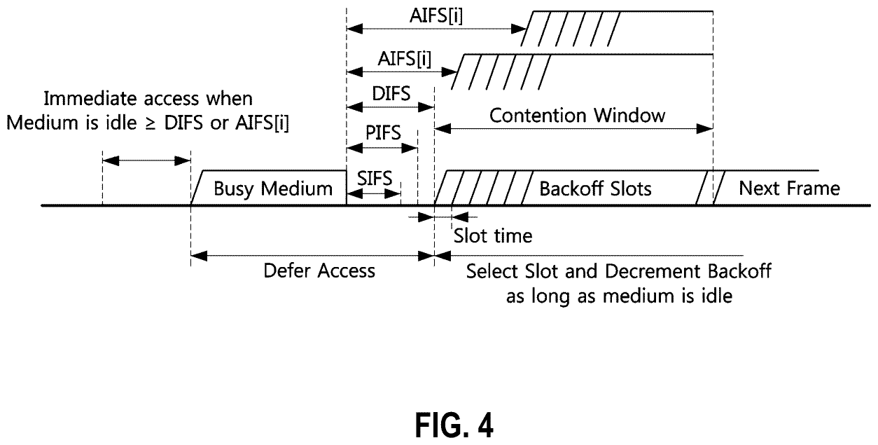

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

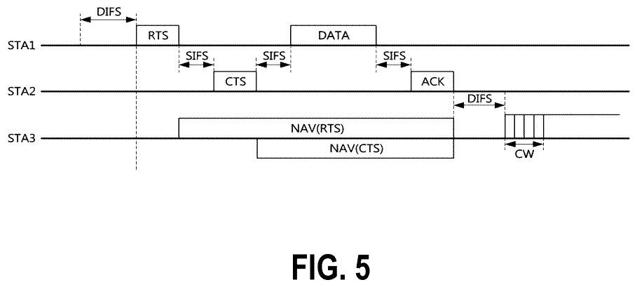

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

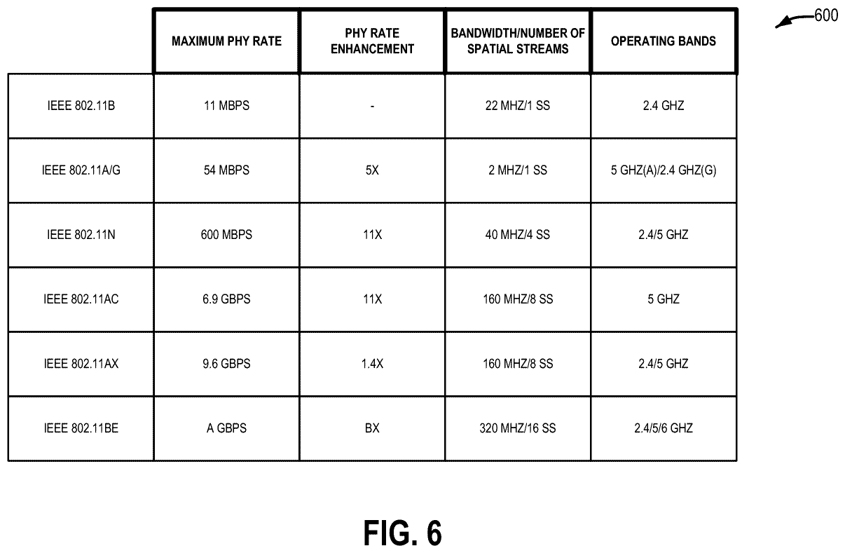

With clear demand for higher peak throughput/capacity in a WLAN, a new working group has been assembled to generate an amendment to IEEE 802.11. This amendment is called IEEE 802.11bc (i.e., Extreme High Throughput (EHT)) and was created to support an increase to the peak PHY rate of a corresponding WLAN. Considering IEEE 802.11b through 802.11ac, the peak PHY rate has been increased by 5× to 11× as shown in FIG. 6, which presents a table 600 comparing various iterations of IEEE 802.11. In case of IEEE 802.11ax, the 802.11ax working group focused on improving efficiency, not peak PHY rate in dense environments. The maximum PHY rate (A Gbps) and PHY rate enhancement (Bx) for IEEE 802.11be could rely on the highest MCS (e.g., 4,096 QAM and its code rate).

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHZ) is being considered for unlicensed use. This would allow APs and STAs to become tri-band devices. Larger than 160 MHz data transmissions (e.g., 320 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

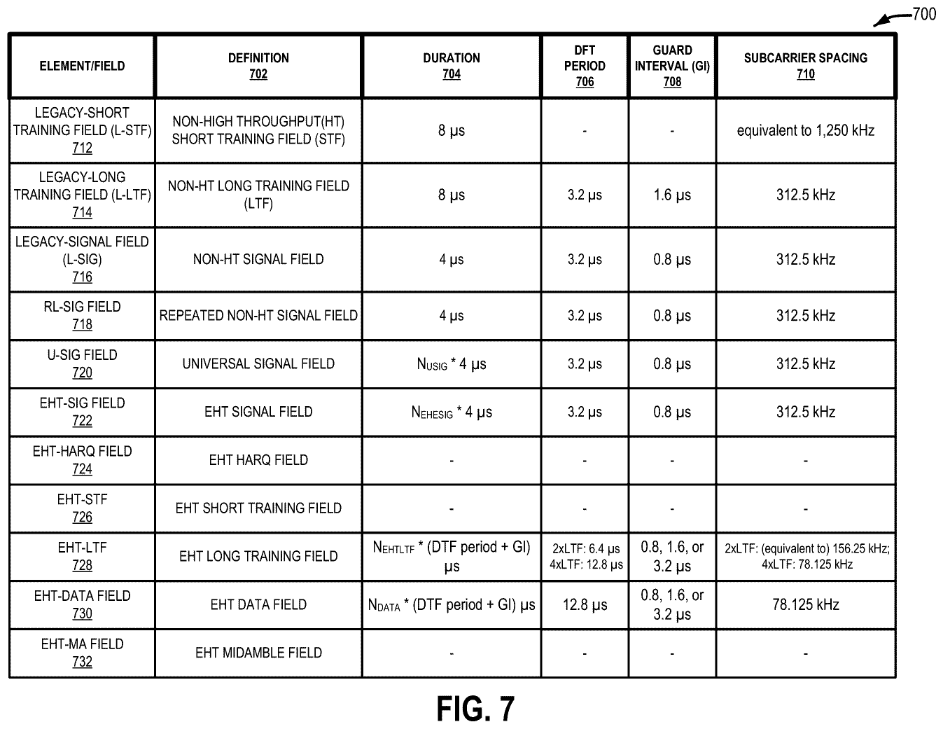

In some embodiments, a transmitting STA generates a PPDU frame and transmits it to a receiving STA. The receiving STA receives, detects, and processes the PPDU. The PPDU can be an EHT PPDU that includes a legacy part (e.g., a legacy short training field (L-STF), a legacy long training field (L-LTF), and a legacy signal (L-SIG) field), an EHT signal A field (EHT-SIG-A), an EHT signal B field (EHT-SIG-B), an EHT hybrid automatic repeat request field (EHT-HARQ), an EHT short training field (EHT-STF), an EHT long training field (EHT-LTF), and an EHT-DATA field. FIG. 7 includes a table 700, which describes fields of an EHT frame format. In particular, table 700 describes various fields that may be within the PHY preamble, data field, and midamble of an EHT frame format. For example, table 700 includes definitions 702, durations 704, Discrete Fourier transform (DFTs) periods 706, guard intervals (GIs) 708, and subcarrier spacings 710 for one or more of a legacy short training field (L-STF) 712, legacy long training field (L-LTF) 714, legacy signal field (L-SIG) 716, repeated L-SIG (RL-SIG) 718, universal signal field (U-SIG) 720, EHT signal field (EHT-SIG) 722, EHT hybrid automatic repeat request field (EHT-HARQ) 724, EHT short training field (EHT-STF) 726, EHT long training field (EHT-LTF) 728, EHT data field 730, and EHT midamble field (EHT-MA) 732.

The distributed nature of a channel access network, such as in IEEE 802.11 wireless networks, makes carrier sensing mechanisms important for collision free operation. The physical carrier sensing mechanism of one STA is responsible for detecting the transmissions of other STAs. However, it may be impossible to detect every single case in some circumstances. For example, one STA which may be a long distance away from another STA may see the medium as idle and begin transmitting a frame while the other STA is also transmitting. To overcome this hidden node, a network allocation vector (NAV) may be used. However, as wireless networks evolve to include simultaneous transmission/reception to/from multiple users within a single basic service set (BSS), such as uplink (UL)/downlink (DL) multi-user (MU) transmissions in a cascading manner, a mechanism may be needed to allow for such a situation. As used herein, a multi-user (MU) transmission refers to cases that multiple frames are transmitted to or from multiple STAs simultaneously using different resources. Examples of different resources are different frequency resources in OFDMA transmissions and different spatial streams in MU-MIMO transmissions. Therefore, DL-OFDMA, DL-MU-MIMO, UL-OFDMA, and UL-MU-MIMO are examples of MU transmissions.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

To improve WLAN systems, AP cooperation has been discussed as a possible technology to be adopted in IEEE 802.11be, where there is high level classification depending on various AP cooperation schemes. For example, there is a first type of cooperation scheme in which data for a user is sent from a single AP (sometimes referred to as “coordinated”) and there is a second type of cooperation scheme in which data for a user is sent from multiple APs (sometimes referred to as “joint”).

For the coordinated scheme, multiple APs are 1) transmitting on the same frequency resource based on coordination and forming spatial nulls to allow for simultaneous transmission from multiple APs or 2) transmitting on orthogonal frequency resources by coordinating and splitting the spectrum to use the spectrum more efficiently. For the joint scheme, multiple APs are transmitting jointly to a given user.

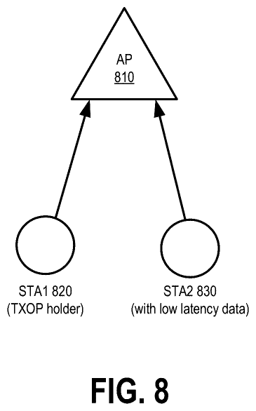

FIG. 8 is a diagram showing a simple WLAN system that includes an AP 810, a first STA (STA1) 820, and a second STA (STA2) 830. The STA1 820 may be the current transmission opportunity (TXOP) holder and STA2 830 may be a LLT (low latency transmission) STA that has low latency data to transmit to the AP 810.

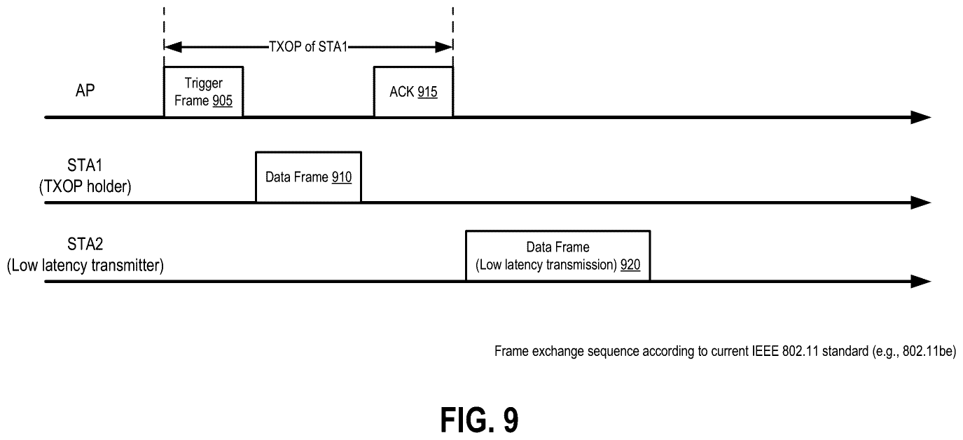

FIG. 9 is a diagram showing a frame exchange sequence in the simple WLAN system according to existing wireless networking standards (e.g., IEEE 802.11ax). As shown in the diagram, the AP may transmit a trigger frame 905 to provide a TXOP for STA1. STA1 is considered to be the TXOP holder in this example. Upon receiving the trigger frame 905, STA1 may transmit a data frame 910 to the AP. Upon successfully receiving the data frame 910, the AP may transmit an acknowledgement (ACK) frame 915 to STA1 to acknowledge the reception of the data frame 910. STA1's 820 TXOP may span the duration of the trigger frame 905, the data frame 910, and the ACK frame 915. STA2, which is a LLT STA, may have low latency data (e.g., emergency data) to transmit to the AP in the middle of STA1's 820 TXOP. As used herein, low latency data refers to data that should be transmitted with lower latency (shorter delays) compared to normal non-low latency data. With existing wireless networking standards, STA2 is not allowed to transmit data to the AP until STA1's 820 TXOP expires. Even after STA1's TXOP expires, STA2 has to compete with other STAs to acquire a channel access opportunity according to DCF rules before being able to transmit data. Thus, as shown in the diagram, at the earliest, STA2 830 may transmit a data frame 920 to the AP after STA1's TXOP expires.

Thus, in existing wireless networking standards, including IEEE 802.11be, STAs are only allowed to transmit a frame after sensing the channel according to the DCF rule. Even though a STA might have low latency data to transmit (data that needs to be transmitted with short delay), the STA cannot transmit the low latency data if the channel is occupied by another STA and the STA is not able to acquire a channel access opportunity. Depending on the application area, however, the ability to transmit data with low latency may be one of the essential requirements. The present disclosure introduces a new transmission scheme, called a RUST transmission scheme, that allows low latency transmission to occur in the middle of a frame transmission.

With embodiments, STA2 may be able to transmit low latency data (or even non-low latency data) to the AP in the middle of STA1's transmission to the AP, without having to wait for STA1's TXOP to expire. If STA1's data frame and STA2's data frame are transmitted simultaneously, they may interfere with each other. To mitigate this problem, a RUST transmission scheme may be used. With the RUST transmission scheme, a STA may generate multiple sub-blocks based on the same source data and transmit the multiple sub-blocks in different resource unit groups (e.g., in different PPDUs in an OFDM manner). The multiple sub-blocks are generated such that a receiver is able to recover the source data based on a subset of the sub-blocks, even if the receiver is not able to successfully receive and decode all of the sub-blocks. The sub-blocks may be generated using a HARQ-based approach or a repetition-based approach, which are described in further detail herein below.

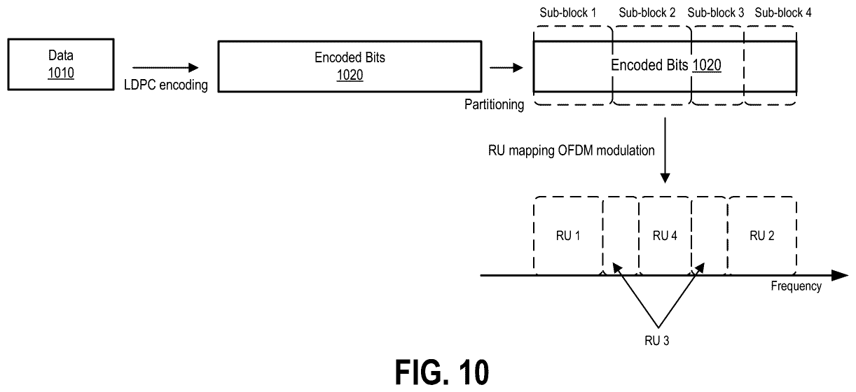

FIG. 10 is a diagram showing a HARQ-based approach for generating sub-blocks for a RUST transmission scheme, according to some embodiments.

As shown in the diagram, source data 1010 may be encoded using LDPC encoding (or other type of error correction encoding) to generate encoded bits 1020. The encoded bits 1020 may be partitioned into multiple sub-blocks. In the example shown in the diagram, the encoded bits 1020 are partitioned into four sub-blocks (labeled as sub-block 1, sub-block 2, sub-block 3, and sub-block 4, respectively). Different sub-blocks may have different sizes. Also, different sub-blocks may contribute differently to the ability of a receiver to recover the source data 1010. In the example shown in the diagram, it is assumed that sub-block 1 contributes the most to the ability to recover the source data, sub-block 2 contributes the next most to the ability to recover the source data, sub-block 3 contributes the next most to the ability to recover the source data, and sub-block 4 contributes the least to the ability to recover the source data. The sub-blocks may be assigned to resource unit groups and modulated in an OFDM manner to form a RUST data frame. A resource unit group may be a group of resource units (e.g., subcarriers). In the example shown in the diagram, there are four resource unit groups (labeled as RU1, RU2, RU3, and RU4, respectively). The resource units of a resource unit group may be contiguous or non-contiguous. For example, in the example shown in the diagram, resource unit groups 1, 2, and 4 include a contiguous group of resource units, while resource unit group 3 includes a non-contiguous group of resource units. As will be further described in additional detail herein, sub-blocks may be assigned to resource unit groups based on the channel gains of the resource unit groups. In the example shown in the diagram, it is assumed that RU1 has the highest channel gain, RU2 has the next highest channel gain, RU3 has the next highest channel gain, and RU4 has the lowest channel gain.

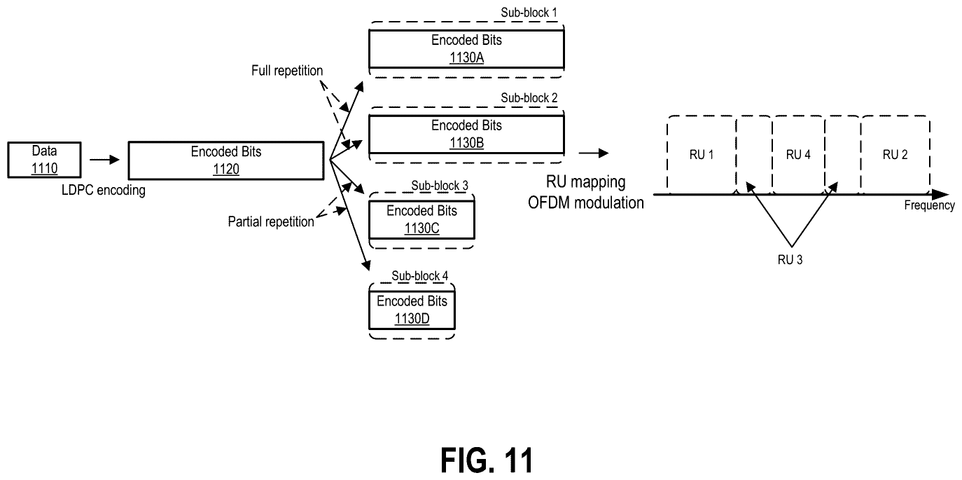

FIG. 11 is a diagram showing a repetition-based approach for generating sub-blocks for a RUST transmission scheme, according to some embodiments. As shown in the diagram, source data 1110 may be encoded using LDPC encoding (or other type of error correction encoding) to generate encoded bits 1120. All of the encoded bits 1120 or a portion of the encoded bits 1120 may be copied to generate multiple sub-blocks. For example, in the example shown in the diagram, there are four sub-blocks (labeled as sub-block 1, sub-block 2, sub-block 3, and sub-block 4, respectively). Sub-blocks 1 and 2 may be generated by copying all of the encoded bits 1120 (that is, sub-blocks 1 and 2 each include all of the encoded bits 1120) and sub-blocks 3 and 4 may be generated by copying just a portion of the encoded bits 1130 (that is, sub-blocks 3 and 4 each include a subset of the encoded bits 1130 and the subset of bits included in each of those sub-blocks may be the same or different from each other). As a result, at least some of the encoded bits 1120 are repeated across more than one sub-block. It is noted that the portion of the encoded bits 1120 that is copied to a sub-block can be any portion of the encoded bits 1120 (e.g., it does not necessarily have to be the bits at the beginning of the encoded bits 1120). Different sub-blocks may have different sizes. For example, as shown in the diagram, sub-blocks 1 and 2 may be larger than sub-block 3 and sub-block 3 may be larger than sub-block 4). Different sub-blocks may contribute differently to the ability of a receiver to recover the source data 1110. In the example shown in the diagram, it is assumed that sub-blocks 1 and 2 contribute the most to the ability to recover the source data (since they include all of the encoded bits 1120), sub-block 3 contributes the next most to the ability to recover the source data, and sub-block 4 contributes the least to the ability to recover the source data. Similar to the HARQ-based approach described above, the sub-blocks may be assigned to resource unit groups (e.g., RU1, RU2, RU3, and RU4) and modulated in an OFDM manner to form a RUST data frame. In the example shown in the diagram, it is assumed that RU1 has the highest channel gain, RU2 has the next highest channel gain, RU3 has the next highest channel gain, and RU4 has the lowest channel gain.

With both the HARQ-based approach and the repetition-based approach, the receiver may be able to recover the source data from the RUST data frame even if the receiver is not able to successfully decode all of the sub-blocks of the RUST data frame (e.g., due to interference of one or more sub-blocks being corrupted). Thus, the receiver may be able to recover the source data from the RUST data frame even if another STA transmits data (e.g., low latency data) in one or more of the resource unit groups during the transmission of the RUST data frame.

As previously mentioned, in an embodiment, the assignment of sub-blocks to resource unit groups is determined based on the channel gains of the resource unit groups. If the RUST transmitter (e.g., STA1 of FIG. 1) has information regarding the channel between the RUST transmitter and the RUST receiver (e.g., AP of FIG. 1), the RUST transmitter may determine which resource unit group (e.g., group of subcarriers) each sub-block should be assigned to based on the channel gains of the resource unit groups. For example, the RUST transmitter may determine that the sub-block that contributes the most to the ability to recover the source data (e.g., sub-block 1 shown in FIG. 10) should be assigned to the resource unit group having the highest channel gain (e.g., RU1 shown in FIG. 10), while the sub-block that contributes the least to the ability to recover the source data (e.g., sub-block 4 shown in FIG. 10) should be assigned to the resource unit group having the lowest channel gain (e.g., RU4 shown in FIG. 10).

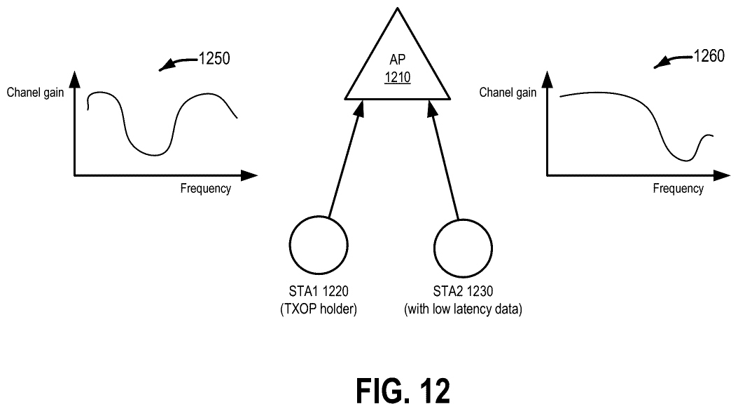

In the example shown in FIGS. 10 and 11, all resource unit groups are used for carrying a sub-block. However, in some embodiments, one or more of the resource unit groups may be punctured (e.g., the resource unit group having the lowest channel gain may be punctured (i.e., no data is transmitted in that resource unit group)) to allow other STAs to transmit low latency data in the punctured resource unit group. FIGS. 12, 13, and 14 show example frequency response of uplink channels, an example assignment of sub-blocks to resource unit groups that is based on the channel gains of the resource unit groups, and an example of a simultaneous transmission of a RUST data frame and a low latency data frame, respectively.

FIG. 12 is a diagram showing example frequency responses of two uplink channels, according to some embodiments. The diagram shows a frequency response 1250 of an uplink channel between STA1 1220 and the AP 1210. As shown in the diagram, the frequency response 1250 of the uplink channel between STA1 1220 and the AP 1210 has higher channel gain in the lower frequencies and higher frequencies, but has lower channel gain in the middle frequencies. Also, the diagram shows a frequency response 1260 of an uplink channel between STA2 1230 and the AP 1210. As shown in the diagram, the frequency response 1260 of the uplink channel between STA2 1230 and the AP 1210 has higher channel gain in the lower frequencies and middle frequencies, but has lower channel gain in the higher frequencies.

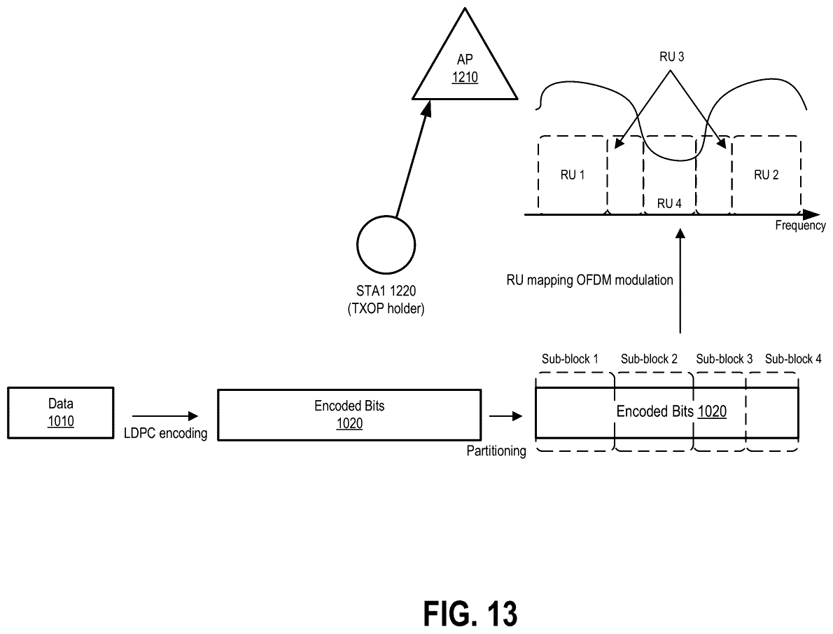

FIG. 13 is a diagram showing an example assignment of sub-blocks to resource unit groups that is based on the channel gains of resource unit groups of the uplink channel between STA1 and the AP, according to some embodiments.

As shown in the diagram, the uplink channel between STA1 1220 and the AP 1210 may be divided into four resource unit groups (RU1, RU2, RU3, and RU4). It is assumed in this example that RU1 has the highest average channel gain, RU2 has the next highest average channel gain, RU3 has the next highest average channel gain, and RU4 has the lowest average channel gain. As previously described, the encoded bits 1020 (e.g., which were generated based on encoding the source data 1010 using LDPC encoding) may be divided into four sub-blocks (sub-block 1, sub-block 2, sub-block 3, and sub-block 4). Each sub-block may contribute differently to the ability to recover the source data 1010. In this example, it is assumed that sub-block 1 contributes the most to the ability to recover the source data 1010, sub-block 2 contributes the next most to the ability to recover the source data 1010, sub-block 3 contributes the next most to the ability to recover the source data 1010, and sub-block 4 contributes the least to the ability to recover the source data 1010. The four sub-blocks may be assigned to the four resource unit groups based on how much the sub-blocks contribute to the ability to recover the source data 1010 and the average channel gains of the resource unit groups. For example, the sub-blocks may be assigned to resource unit groups such that the sub-block that contributes the most to the ability to recover the source data 1010 is assigned to the resource unit group having the highest channel gain, the sub-block that contributes the next most to the ability to recover the source data 1010 is assigned to the resource unit group having the next highest channel gain, and so on. Following this approach, in the example shown in the diagram, sub-block 1 may be assigned to RU1, sub-block 2 may be assigned to RU2, sub-block 3 may be assigned to RU3, and sub-block 4 may be assigned to RU4. The sub-blocks may be modulated in an OFDM manner (in accordance with the assignment of sub-blocks to resource unit groups) to form a RUST data frame. While an example that uses a HARQ-based approach is shown in the diagram and described, it should be appreciated that sub-blocks may be assigned to resource unit groups in a similar manner when using a repetition-based approach.

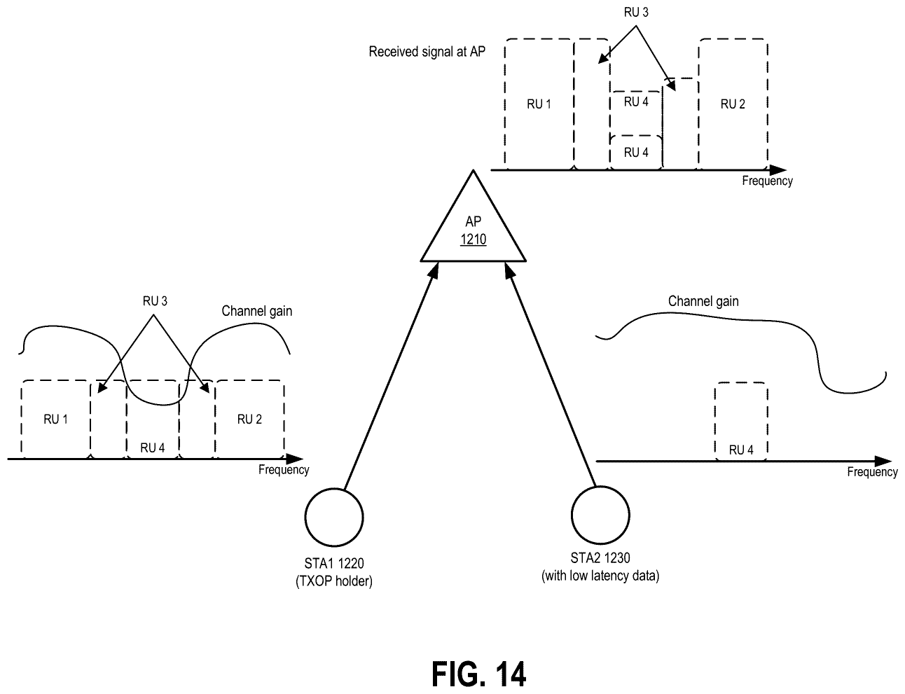

FIG. 14 is a diagram showing an example of a simultaneous transmission of a RUST data frame and a low latency data frame, according to some embodiments.

As shown in the diagram, STA1 1220 may transmit the sub-blocks that form the RUST data frame in RU1, RU2, RU3, and RU4. Continuing with the example provided above, sub-block 4 (which contributes the least to the ability to recover the source data among the sub-blocks) may be transmitted in RU4 (which has the lowest channel gain among the resource unit groups). The AP 1210 may be able to recover the source data included in the RUST data frame even if it is not able to successfully receive and decode sub-block 4.

STA2 1230, which is a LLT STA that has low latency data, may transmit a low latency data frame in RU4 in the middle of the RUST data frame transmission. As shown in the diagram, at the AP-side, the channel gain of RU4 from STA2's 1230 transmission may be higher than the channel gain of RU4 from STA1's 1220 transmission. Thus, the AP 1210 will likely be able to decode the low latency data frame transmitted by STA2 1230. At the same time, the AP 1210 may be able to decode the RUST data frame transmitted by STA1 1220 based on decoding one or more of the sub-blocks, even if the AP 1210 is not able to decode sub-block 4 (e.g., due to interference from the low latency data frame transmitted by STA2 1230). In an embodiment, to increase the probability of the AP 1210 being able to decode the low latency data frame, STA2 1230 may increase the transmit power and/or select a particular transmission rate (e.g., select a modulation and coding scheme that has a lower data rate) to use when transmitting the low latency data frame. This may allow the AP to decode the low latency data frame even in the presence of interference from the RUST data frame transmitted by STA1 1220. Thus, by virtue of STA1 1220 using the RUST transmission scheme and STA2 1230 transmitting its low latency data frame in a particular resource unit group (e.g., the resource unit group that carries the sub-block that contributes the least to the ability to recover the source data of the RUST data frame), the AP 1210 may be able to decode both the RUST data frame and the low latency data frame.

To decode the low latency data frame even in the presence of interference from the RUST data frame, the AP 1210 may monitor the resource unit groups that can be used for low latency transmission to check for arrival of a potential low latency data frame. In an embodiment, for easy detection of low latency data frames, a new frame structure occupying a given resource unit group can be considered. In an embodiment, if resource unit groups are defined in units of 20 MHz subchannels, a frame detection algorithm with L-STF and/or L-LTF can be used to detect low latency data frames. In an embodiment, for a 160 MHz channel bandwidth that includes eight 20 MHz subchannels, there may be four resource unit groups, each resource unit group having a bandwidth of 40 MHz. Alternatively, there may be four resource unit groups, with a first resource unit group having a bandwidth of 80 MHz, a second resource unit group having a bandwidth of 40 MHz, a third resource unit group having a bandwidth of 20 MHz, and a fourth resource unit group having a bandwidth of 20 MHZ. In an embodiment, the channel gain feedback can be used to determine the resource unit group size (i.e., the bandwidths of resource unit groups). For example, the resource unit(s) that have a higher channel gain than the average channel gain of the entire bandwidth can form one resource unit group and the other resource units can form the remaining resource unit groups. While certain configurations of the resource unit groups are provided above, it should be appreciated that other configurations are possible.

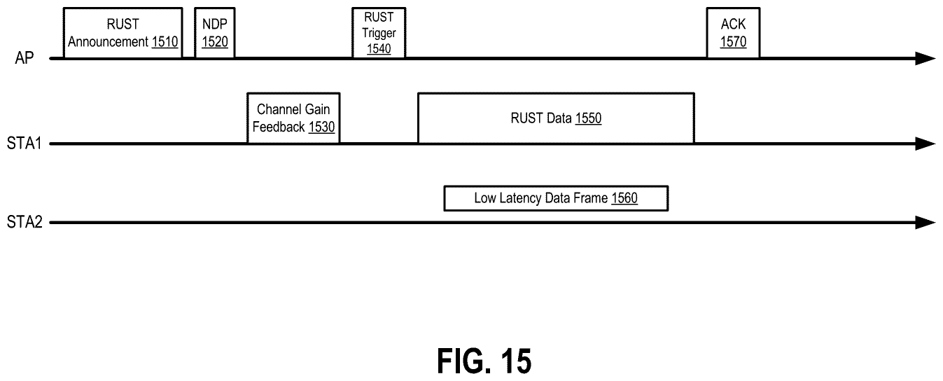

FIG. 15 is a diagram showing an example of a frame exchange sequence for a RUST transmission scheme, according to some embodiments.

To initiate a RUST transmission and deliver the information for implementing a RUST transmission scheme, several new frames may be defined and a new frame exchange sequence may be introduced, as described herein below.

As shown in the diagram, the AP may transmit a RUST announcement frame 1510. The RUST announcement frame 1510 may be used to initiate a RUST transmission. The RUST announcement frame 1510 may include information regarding the size/bandwidth and location of the resource unit groups. For example, the information may indicate that the resource unit groups include 26-tone, 52-tone, or 106-tone resource units (which are defined in IEEE 802.11be). The receiver of the RUST announcement frame 1510, which may be STA1 in this example, may use the information regarding the resource unit size to determine the average channel gains of the different resource units at the receiver. For example, if the resource unit size is 26 tones, STA1 may determine the average channel gains of 26-tone resource units. When the primary 20 MHz subchannel should always be used for RUST transmissions, such information can be delivered with the resource unit group allocation information (e.g., this allocation information indicates the location of the resource units used for channel gain feedback).

After transmitting the RUST announcement frame 1510, the AP may transmit a null data packet (NDP) frame 1520 for channel estimation. Upon receiving the NDP frame 1520, STA1 may determine the average channel gains of each resource unit or each resource unit group. STA1 may then transmit a channel gain feedback frame 1530 to the AP that includes information regarding the channel gains of the resource units or resource unit groups.

Upon receiving the channel gain feedback frame 1530 from STA1, the AP may transmit a RUST trigger frame 540. The RUST trigger frame 1540 may include information regarding the assignment of sub-blocks to resource unit groups, information regarding the RUST approach that is to be used (e.g., HARQ-based approach or repetition-based approach), information regarding which resource unit groups can be used to transmit low latency data (which may be referred to as the LLT-allowed resource unit group(s)), and/or information regarding which STAs are allowed to transmit low latency data (e.g., LLT-allowed STA IDs). It should be appreciated that the RUST trigger frame 1540 can include other information related to the RUST transmission scheme and/or low latency transmission.

In the example frame exchange sequence shown in the diagram, the AP transmits a NDP frame 1520 to STA1 to allow STA1 to determine the channel gains of the resource units or resource unit groups. STA1 then feeds back the channel gain information to the AP. The channel gain determined by STA1 is the downlink channel gain, but it can be used by the AP as an approximation of the uplink channel gain. In another embodiment, STA1 transmits a NDP frame to the AP and the AP determines the channel gains of the resource units or resource unit groups based on the NDP frame. The AP may then transmit information regarding the channel gains of the resource units or the resource unit groups to STA1. Thus, the way in which channel estimation is performed can be based on 1) the AP transmitting a NDP frame to STA1; or 2) STA1 transmitting a NDP frame to the AP. It should be appreciated that the AP and/or STA1 can determine the channel gains in other ways.

The diagram shows an example of using a RUST transmission scheme for uplink transmission (e.g., from STA1 and STA2 to the AP). It should be appreciated, however, that the RUST transmission scheme can also be used for downlink transmission and/or be used for transmission between two different transmitter-receiver pairs (two STAs to two STAs). For example, for downlink transmission, STA1 may be a RUST initiator and transmit a RUST announcement frame and NDP frame. In response, the AP may transmit a channel gain feedback frame to STA1. Based on the channel gain information included in the channel gain feedback frame, STA1 may transmit a RUST trigger frame. Responsive to receiving the RUST trigger frame, the AP may transmit a RUST data frame to STA1 using the full bandwidth and STA2 may transmit a data frame using a partial bandwidth. The receiver of STA2's data frame may be STA1 or another STA or the AP. As another example, for transmission between two different transmitter-receiver pairs, STA1 may be a RUST initiator and transmit a RUST announcement frame and NDP frame. In response, STA2 may transmit a channel gain feedback frame to STA1. Based on the channel gain information included in the channel gain feedback frame, STA1 may transmit a RUST trigger frame. Responsive to receiving the RUST trigger frame, STA2 may transmit a RUST data frame to STA1 using the full bandwidth and another STA (STA3) may transmit a data frame using a partial bandwidth. The receiver of STA3's data frame may be yet another STA (STA4). Thus the two transmitter-receiver pairs can be 1) STA2 and STA1; and 2) STA3 and STA4.

The examples described herein consider a scenario where there is a single LLT STA. If there are multiple LLT STAs (each having low latency data to transmit), the multiple LLT STAs may be assigned to multiple LLT-allowed resource unit groups (resource unit groups in which low latency data may be transmitted). If the number of LLT-allowed resource unit groups is larger than the number of potential LLT STAs that have low latency data, the AP may assign each LLT STA to a different LLT-allowed resource unit group. When assigning LLT STAs to LLT-allowed resource unit groups, the AP may consider the average channel gains of the LLT STAs in each resource unit group, and assign LLT STAs to the corresponding resource unit groups for which they have high channel gain to secure the high-quality LLT link. If the number of LLT-allowed resource unit groups is less than the number of potential LLT STAs having low latency data, the AP may assign multiple LLT STAs to a single resource unit group. In this case, multiple LLT STAs may have to contend with each other to transmit low latency data in the same resource unit group. If the AP wants to provide different access priorities to different LLT STAs, the AP may define different CCA (clear channel assessment) levels and backoff policies for each LLT STA. For example, the AP may allow the LLT STA with the highest priority to access a given resource unit group without channel sensing (e.g., with a very high CCA level and no backoff). The average channel gain, which is a measure of the LLT link quality, can be regarded as a priority factor because the LLT STA with the higher average channel gain may be able to transmit low latency data at a high data rate. The AP may obtain the channel gains of the LLT STAs based on previous frame exchanges with those LLT STAs if obtaining explicit channel feedback is not possible.

There is a possibility that the duration of a low latency data frame is longer than that of a RUST data frame. To prevent such a case, the RUST trigger frame may include information regarding the maximum allowed duration for a low latency data frame. If an LLT STA has more low latency data to transmit in its buffer than what can fit in a single low latency data frame, the LLT STA may first transmit a low latency data frame with a portion of the low latency data (e.g., whatever can fit in the low latency data frame without exceeding the maximum allowed duration) and include an indication in that low latency data frame that the LLT STA has more low latency data to transmit in its buffer. Based on seeing this indication, the AP may provide a TXOP to the LLT STA to allow the LLT STA to transmit the remaining low latency data without contention.

The RUST transmission scheme described herein may allow a LLT STA to transmit low latency data to a receiver while a RUST data frame is being transmitted to the receiver by another STA with a TXOP. Even in the case that a LLT STA transmits low latency data to the receiver in the middle of a RUST data frame, the receiver may still be able to successfully decode both the RUST data frame and the low latency data frame, as the low latency data may be transmitted in a resource unit group that is being used to carry a sub-block that is not necessarily needed by the receiver to recover the source data included in the RUST data frame.

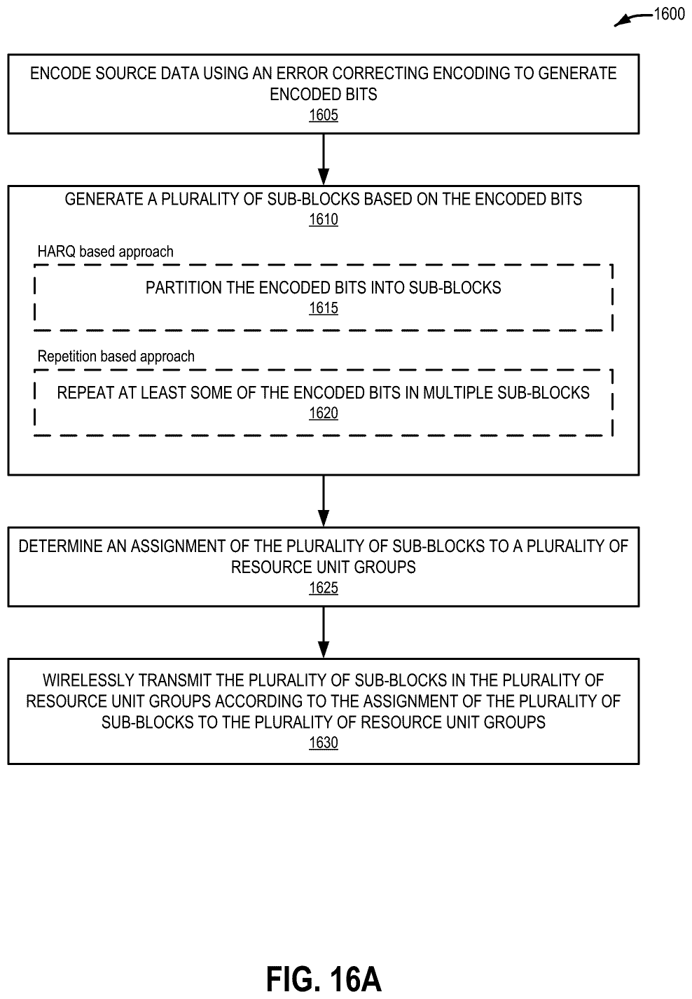

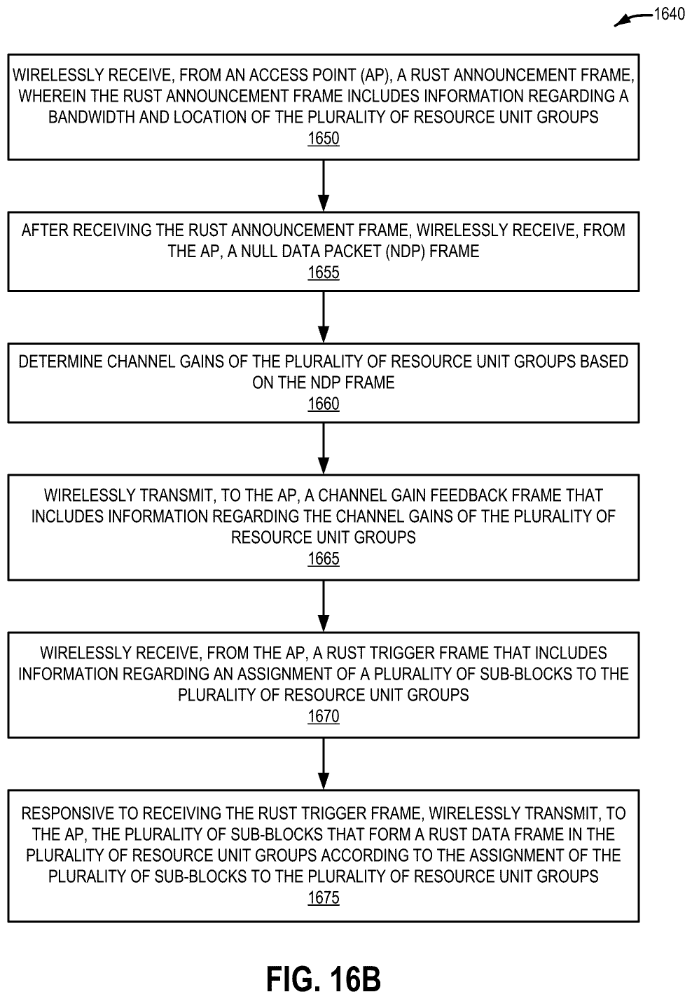

Turning now to FIG. 16A, a method 1600 will be described for transmitting data using a RUST transmission scheme, in accordance with an example embodiment. The method 1600 may be performed by one or more devices described herein. For example, the method 1600 may be performed by a wireless device 104 functioning as a STA (e.g., STA1 of FIG. 15) in a wireless network.

Additionally, although shown in a particular order, in some embodiments the operations of the method 1600 (and the other methods shown in the other figures) may be performed in a different order. For example, although the operations of the method 1600 are shown in a sequential order, some of the operations may be performed in partially or entirely overlapping time periods.

At operation 1605, the STA encodes source data using an error correcting encoding to generate encoded bits.

At operation 1610, the STA generates a plurality of sub-blocks based on the encoded bits. In a HARQ-based approach, operation 1610 may involve operation 1615 in which the STA partitions the encoded bits into (e.g., non-overlapping) sub-blocks. In a repetition-based approach, operation 1610 may involve operation 1620 in which the STA repeats at least some of the encoded bits in multiple sub-blocks. In an embodiment, the plurality of sub-blocks includes a first sub-block and a second sub-block that are different in size.

At operation 1625, the STA determines an assignment of the plurality of sub-blocks to plurality of resource unit groups. In an embodiment, the STA determines channel gains of the plurality of resource unit groups, wherein the assignment of the plurality of sub-blocks to the plurality of resource unit groups is generated based on the channel gains of the plurality of resource unit groups. In an embodiment, the STA determines the assignment of the plurality of sub-blocks to the plurality of resource groups based on information included in a RUST trigger frame transmitted by an AP. In an embodiment, a sub-block from the plurality of sub-blocks that contributes least to an ability to recover the source data is assigned to a resource unit group from the plurality of resource unit groups that is determined to have a lowest channel gain. In an embodiment, each of the plurality of resource unit groups has a bandwidth that is a multiple of 20 MHz. In an embodiment, the plurality of resource unit groups includes four resource unit groups, with each resource unit group having a bandwidth of 40 MHz. In an embodiment, the plurality of resource unit groups includes a first resource unit group, a second resource unit group, a third resource unit group, and a fourth resource unit group, wherein the first resource unit group has a bandwidth of 80 MHz, the second resource unit group has a bandwidth of 40 MHz, the third resource unit group has a bandwidth of 20 MHz, and the fourth resource unit group has a bandwidth of 20 MHz. In an embodiment, the plurality of resource unit groups includes a resource unit group that includes at least two non-contiguous resource units (e.g., RU3 in the example provided herein above).

At operation 1630, the STA wirelessly transmits the plurality of sub-blocks in the plurality of resource unit groups (e.g., in different PPDUS in an OFDM manner) according to the assignment of the plurality of sub-blocks to the plurality of resource unit groups.

Turning now to FIG. 16B, a method 1640 will be described for transmitting a RUST data frame in response to receiving a RUST trigger frame, in accordance with an example embodiment. The method 1640 may be performed by one or more devices described herein. For example, the method 1600 may be performed by a wireless device 104 functioning as a STA (e.g., STA1 of FIG. 15) in a wireless network.

At operation 1650, the STA wirelessly receives, from an AP, a RUST announcement frame, wherein the RUST announcement frame includes information regarding a bandwidth and location of the plurality of resource unit groups.

At operation 1655, after receiving the RUST announcement frame, the STA wirelessly receives, from the AP, a NDP frame.

At operation 1660, the STA determines channel gains of the plurality of resource unit groups based on the NDP frame.

At operation 1665, the STA wirelessly transmits, to the AP, a channel gain feedback frame that includes information regarding the channel gains of the plurality of resource unit groups (or individual resource units).

At operation 1670, the STA wirelessly receives, from the AP, a RUST trigger frame that includes information regarding an assignment of a plurality of sub-blocks to the plurality of resource unit groups. In an embodiment, the RUST trigger frame includes one or more of: information regarding the assignment of the plurality of sub-blocks to the plurality of resource unit groups, information regarding a RUST approach that the STA is to use, information regarding which of the plurality of resource unit groups can be used to transmit low latency data, and information regarding which STAs are allowed to transmit low latency data.

At operation 1675, responsive to receiving the RUST trigger frame, the STA wirelessly transmits, to the AP, the plurality of sub-blocks that form a RUST data frame in the plurality of resource unit groups according to the assignment of the plurality of sub-blocks to the plurality of resource unit groups.

In an embodiment, the STA wirelessly transmits a NDP frame to the AP to allow the AP to determine channel gains of the plurality of resource unit groups based on the NDP frame (e.g., instead of transmitting the channel gain feedback frame to the AP).

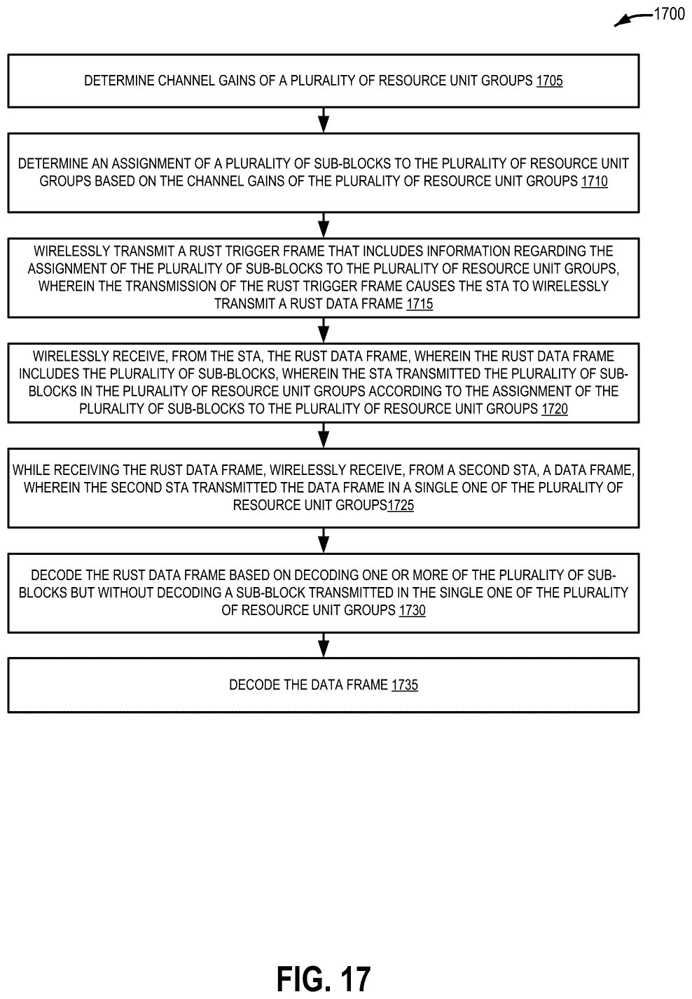

Turning now to FIG. 17, a method 1700 will be described for initiating a RUST transmission, in accordance with an example embodiment. The method 1700 may be performed by one or more devices described herein. For example, the method 1700 may be performed by a wireless device 104 functioning as an AP (e.g., the AP of FIG. 15) in a wireless network.

At operation 1705, the AP determines channel gains of a plurality of resource unit groups. In an embodiment, the AP wirelessly transmits a RUST announcement frame that includes information regarding a bandwidth and location of the plurality of resource unit groups, wirelessly transmits a NDP frame following the transmission of the RUST announcement frame, and wirelessly receives, from the STA, a channel gain feedback frame that includes information regarding the channel gains of the plurality of resource unit groups (or individual resource units), wherein the STA determined the channel gains of the plurality of resource unit groups (or individual resource units) based on the NDP frame, and wherein the AP determines the channel gains of the plurality of resource unit groups based on the information included in the channel gain feedback frame. In an alternative embodiment, the AP wirelessly receives a NDP frame from the STA, wherein the AP determines the channel gains of the plurality of resource unit groups based on the NDP frame. In an embodiment, each of the plurality of resource unit groups has a bandwidth that is a multiple of 20 MHz. In an embodiment, the plurality of resource unit groups includes four resource unit groups, with each resource unit group having a bandwidth of 40 MHz. In an embodiment, the plurality of resource unit groups includes a first resource unit group, a second resource unit group, a third resource unit group, and a fourth resource unit group, wherein the first resource unit group has a bandwidth of 80 MHZ, the second resource unit group has a bandwidth of 40 MHz, the third resource unit group has a bandwidth of 20 MHz, and the fourth resource unit group has a bandwidth of 20 MHZ.

At operation 1710, the AP determines an assignment of a plurality of sub-blocks to the plurality of resource unit groups based on the channel gains of the plurality of resource unit groups.

At operation 1715, the AP wirelessly transmits a RUST trigger frame that includes information regarding the assignment of the plurality of sub-blocks to the plurality of resource unit groups, wherein the transmission of the RUST trigger frame causes the STA to wirelessly transmit a RUST data frame. In an embodiment, the RUST trigger frame further includes information regarding a RUST approach that the STA is to use, wherein the RUST approach is one of: a HARQ-based approach and a repetition-based approach. In an embodiment, the RUST trigger frame further includes information regarding which of the plurality of resource unit groups can be used to transmit low latency data during the transmission of the RUST data frame. In an embodiment, more than one of the plurality of resource unit groups can be used to transmit low latency data during the transmission of the RUST data frame. In an embodiment, the RUST trigger frame further includes information regarding which STAs are allowed to transmit low latency data during the transmission of the RUST data frame. In an embodiment, multiple STAs are allowed to contend for a single one of the plurality of resource unit groups to transmit low latency data during the transmission of the RUST data frame. In an embodiment, different ones of the multiple STAs are assigned different transmission priorities.

At operation 1720, the AP wirelessly receives, from the STA, the RUST data frame, wherein the RUST data frame includes the plurality of sub-blocks, wherein the STA transmitted the plurality of sub-blocks in the plurality of resource unit groups according to the assignment of the plurality of sub-blocks to the plurality of resource unit groups.

At operation 1725, while receiving the RUST data frame, the AP wirelessly receives, from a second STA, a data frame, wherein the second STA transmitted the data frame in a single one (or a subset) of the plurality of resource unit groups. In an embodiment, the data frame is a low latency data frame that includes low latency data (but may be a normal non-low latency data frame that includes non-low latency data in other embodiments).

At operation 1730, the AP decodes the RUST data frame based on decoding one or more of the plurality of sub-blocks but without decoding a sub-block transmitted in the single one (or the subset) of the plurality of resource unit groups.

At operation 1735, the AP decodes the data frame.

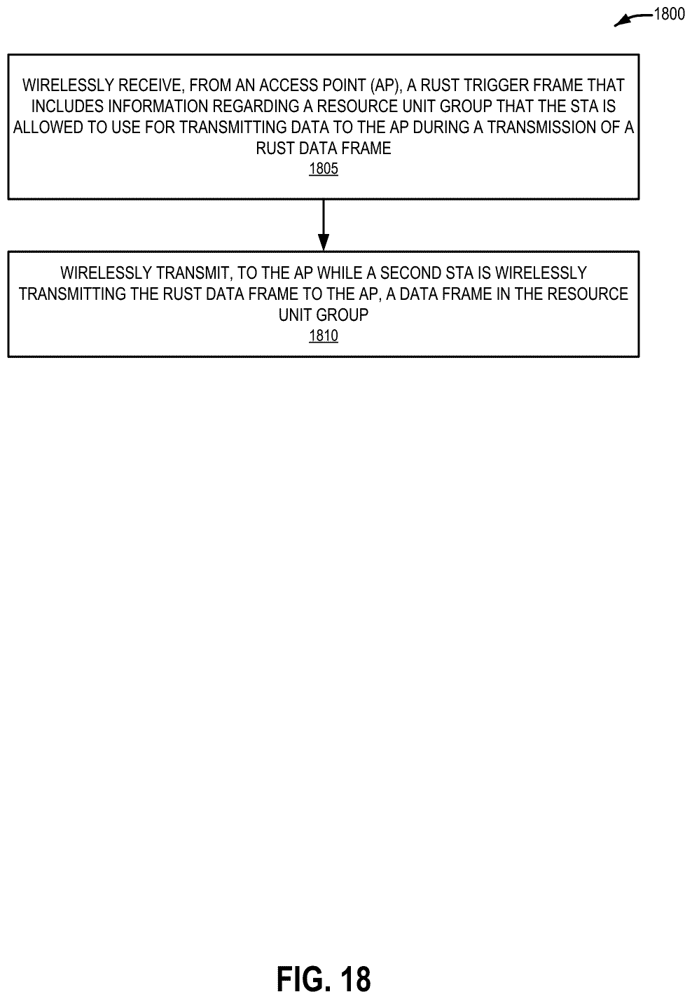

Turning now to FIG. 18, a method 1800 will be described for transmitting a data frame in the middle of a RUST data frame transmission, in accordance with an example embodiment. The method 1800 may be performed by one or more devices described herein. For example, the method 1600 may be performed by a wireless device 104 functioning as a STA (e.g., STA2 of FIG. 15) in a wireless network.

At operation 1805, the STA wirelessly receives, from an AP, a RUST trigger frame that includes information regarding a resource unit group that the STA is allowed to use for transmitting data to the AP during a transmission of a RUST data frame.

At operation 1810, the STA wirelessly transmits, to the AP while a second STA is wirelessly transmitting the RUST data frame to the AP, a data frame in the resource unit group. In an embodiment, the data frame is a low latency data frame that includes low latency data (but may be a normal non-low latency data frame that includes non-low latency data in other embodiments). In an embodiment, the data frame is transmitted using a higher transmit power and/or a lower data transmission rate compared to other data frames that the STA transmits when the second STA is not transmitting the RUST data frame.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A method performed by a wireless device functioning as a station (STA) in a wireless network to transmit data using a resource unit selective transmission (RUST) transmission scheme, the method comprising:
encoding source data using an error correcting encoding to generate encoded bits;
generating a plurality of sub-blocks based on the encoded bits;
determining an assignment of the plurality of sub-blocks to a plurality of resource unit groups; and
wirelessly transmitting the plurality of sub-blocks in the plurality of resource unit groups according to the assignment of the plurality of sub-blocks to the plurality of resource unit groups.

2. The method of claim 1, wherein the plurality of sub-blocks is generated based on partitioning the encoded bits into sub-blocks.

3. The method of claim 1, wherein the plurality of sub-blocks is generated based on repeating at least some of the encoded bits in multiple sub-blocks.

4. The method of claim 1, wherein the plurality of sub-blocks includes a first sub-block and a second sub-block that are different in size.

5. The method of claim 1, further comprising:
determining channel gains of the plurality of resource unit groups, wherein the assignment of the plurality of sub-blocks to the plurality of resource unit groups is generated based on the channel gains of the plurality of resource unit groups.

6. The method of claim 5, wherein a sub-block from the plurality of sub-blocks that contributes least to an ability to recover the source data is assigned to a resource unit group from the plurality of resource unit groups that is determined to have a lowest channel gain.

7. The method of claim 1, wherein the plurality of resource unit groups includes four resource unit groups with each resource unit group having a bandwidth of 40 Megahertz (MHz).

8. The method of claim 1, wherein each of the plurality of resource unit groups has a bandwidth that is a multiple of 20 MHz.

9. The method of claim 1, further comprising:
wirelessly receiving, from an access point (AP), a RUST announcement frame, wherein the RUST announcement frame includes information regarding a bandwidth and location of the plurality of resource unit groups;
after receiving the RUST announcement frame, wirelessly receiving, from the AP, a null data packet (NDP) frame;
determining channel gains of the plurality of resource unit groups based on the NDP frame;
wirelessly transmitting, to the AP, a channel gain feedback frame that includes information regarding the channel gains of the plurality of resource unit groups; and
wirelessly receiving, from the AP, a RUST trigger frame that includes information regarding the assignment of the plurality of sub-blocks to the plurality of resource unit groups, wherein the STA transmits the plurality of sub-blocks in response to receiving the RUST trigger frame from the AP.

10. The method of claim 9, wherein the RUST trigger frame further includes one or more of: information regarding a RUST approach that the STA is to use, information regarding which of the plurality of resource unit groups can be used to transmit low latency data, and information regarding which STAs are allowed to transmit low latency data.

11. The method of claim 1, further comprising:
wirelessly transmitting a null data packet (NDP) frame to an access point (AP) to allow the AP to determine channel gains of the plurality of resource unit groups based on the NDP frame.

12. The method of claim 1, wherein the plurality of resource unit groups includes a resource unit group that includes at least two non-contiguous resource units.

13. A method performed by a wireless device functioning as an access point (AP) in a wireless network to support a resource unit selective transmission (RUST) transmission scheme, the method comprising:
determining channel gains of a plurality of resource unit groups;
determining an assignment of a plurality of sub-blocks to the plurality of resource unit groups based on the channel gains of the plurality of resource unit groups; and
wirelessly transmitting a RUST trigger frame that includes information regarding the assignment of the plurality of sub-blocks to the plurality of resource unit groups, wherein the transmission of the RUST trigger frame causes a STA to wirelessly transmit a RUST data frame.

14. The method of claim 13, further comprising:
wirelessly receiving, from the STA, the RUST data frame, wherein the RUST data frame includes the plurality of sub-blocks, wherein the STA transmitted the plurality of sub-blocks in the plurality of resource unit groups according to the assignment of the plurality of sub-blocks to the plurality of resource unit groups; and
while receiving the RUST data frame, wirelessly receiving, from a second STA, a data frame, wherein the second STA transmitted the data frame in a single one of the plurality of resource unit groups.

15. The method of claim 14, further comprising:
decoding the RUST data frame based on decoding one or more of the plurality of sub-blocks but without decoding a sub-block transmitted in the single one of the plurality of resource unit groups; and
decoding the data frame.

16. The method of claim 15, wherein the data frame is a low latency data frame that includes low latency data.

17. The method of claim 13, further comprising:
wirelessly transmitting a RUST announcement frame that includes information regarding a bandwidth and location of the plurality of resource unit groups;
wirelessly transmitting a null data packet (NDP) frame following the transmission of the RUST announcement frame; and
wirelessly receiving, from the STA, a channel gain feedback frame that includes information regarding the channel gains of the plurality of resource unit groups, wherein the STA determined the channel gains of the plurality of resource unit groups based on the NDP frame, wherein the AP determines the channel gains of the plurality of resource unit groups based on the information included in the channel gain feedback frame.

18. The method of claim 13, further comprising:
wirelessly receiving a null data packet (NDP) frame from the STA, wherein the AP determines the channel gains of the plurality of resource unit groups based on the NDP frame.

19.-29. (canceled)

30. A wireless device to function as a station (STA) in a wireless network, the wireless device comprising:
a radio frequency transceiver;
a memory device storing a set of instructions; and
a processor coupled to the memory device, wherein the set of instructions when executed by the processor causes the STA to:
encode source data using an error correcting encoding to generate encoded bits, generate a plurality of sub-blocks based on the encoded bits,
determine an assignment of the plurality of sub-blocks to a plurality of resource unit groups, and
wirelessly transmit the plurality of sub-blocks in the plurality of resource unit groups according to the assignment of the plurality of sub-blocks to the plurality of resource unit groups.
